(19) United States
(12) Patent Application Publication
(10) Pub. No.: US 2004/0128247 A1
(43) Pub. Date: Jul. 1, 2004

(54) Bank system program, credit service program and IC card

(75) Inventors: Akiko Sato, Musashino (JP); Yusuke Mishina, Kunitachi (JP)

Correspondence Address: REED SMITH LLP, 3110 FAIRVIEW PARK DRIVE, SUITE 1400, FALLS CHURCH, VA, 22042, US

(73) Assignee: Hitachi., Ltd.

(21) Appl. No.: 10/735,872

(22) Filed: Dec. 16, 2003

(30) Foreign Application Priority Data
Dec. 20, 2002 (JP) 2002-369174

(51) Int. Cl. G06F 17/60

(52) U.S. Cl. 705/41; 705/39

(57) ABSTRACT

According to the present invention, there is provided a credit settlement system which enables a bank system and a credit system to be linked to each other by storing data representing information on payment received from any user in an IC card, enables the user to deposit in his or her bank account the payment for any transaction on credit, and enables the user to make a transaction on credit reflecting the payment receipt information even immediately after that deposit.

### FIELD OF THE INVENTION

The present invention relates to a payment processing system using IC cards and linking a credit service system and a bank service system.

### BACKGROUND OF THE INVENTION

According to the prior art, when a transaction on credit is made by using a credit card, the payment to settle that transaction is made by deduction from the user's bank account on a prescribed day or electronic bank transfer of either cash or check. The buyer pays the payable sum by the due date in accordance with a bill sent from the credit card company. The credit card company, after confirming the receipt of the sum transferred from the bank or the card bearer, raises the pertinent user's financial status by the sum paid. In recent years, multi-application IC cards each of which can be mounted with a plurality of services have come into expanding use in place of magnetic cards, but the payment processing for such IC cards is no different from what was described above. On a single multi-application IC card, an IC card application (AP) for credit service and an AP for handling deposits in and withdrawals-from a bank account can coexist.

The example of the prior art described above involves a problem that, where the payment to settle the credit account is made by an automatic deduction from the user's bank account, it takes a few days for that payment to be reflected in the financial status recognized by the credit card company from the time the user deposits the payable sum in his or her bank account and that sum is transferred. There is another problem that, whereas most credit card holders opt for this payment system of automatic deduction from the bank account, this system cannot meet the desire of card bearers who “want to pay the debit now on a real time basis” or “want to have the paid sum reflected in the financial status now on a real time basis”. These problems will be discussed in detail below.

FIG. 1 illustrates the configuration of a payment processing system for credit service according to the prior art. First, the constituent elements of the system will be outlined.

Reference numeral 101 denotes a bank service provider system (hereinafter abbreviated to bank system), which is used by a bank to perform the management of customer information and account information and usual banking functions including the processing of deposits in and withdrawals from customers' accounts and automatic transfers in and out. This system comprises a server for bank service provider (102) and a client for bank service provider (105). The server for bank service provider has a user's bank account (103) and a bank service processing unit (104). Clients for bank service provider are so-called ATM terminals, installed in the branches of banks and elsewhere for direct access by users.

Reference numeral 121 denotes a credit service provider system (hereinafter abbreviated to credit system), which is used by a credit card company to perform credit service functions including the management of customer information and credit card information, financial status confirmation and payment processing. The system comprises a server for credit service provider (122) and clients for credit service provider (125). The server for credit service provider has a credit service processing unit (123) for performing credit service functions and a database (124) having data which includes client information, card information, customers' financial status information and the like. Clients for credit service provider are installed in retail establishments under contract with the credit card company, and have clients for handling credit services including shopping on credit and small loan lending service.

The exchange of information between the bank system and the credit system is accomplished via a public network or a private line network or by mailing or directly delivering a hard copy or an information recording medium. Between the clients and the server of each system, information is exchanged via a public network or a private line network.

The bank system (101) and the credit system (121) have, in their respective processing units (104 and 123), functions for processing such banking routines as account management and deposits in and withdrawals from bank accounts, and credit service processing functions including credit account settlement and confirmation of financial status information. These processing functions are realized and operate as computer programs.

Next will be described problems with the conventional system with reference to the operating procedures of transaction on credit and payment processing by way of example.

A user (111) having made a transaction on credit accesses (131) a client for bank service provider (105) not later than the prescribed day of deduction from his or her account, and deposits (132) the payable sum in the user's bank account (103). When the settlement day comes, the bank service processing unit (104) withdraws the sum specified by the credit card company from the user's bank account (103), and transfers (138) the sum to the credit service processing unit (123). The credit service processing unit (123) confirms the transferred sum, and updates the user's data related to financial status (124). The data related to financial status include the user's credit line and outstanding liability. When the user moves to a client for credit service provider (125) (133) and demands a transaction on credit (134), the client for credit service provider checks the data related to financial status (135), receives the result (136), and informs the user of whether or not the demanded transaction is allowed (137).

A first problem here with the conventional system is that the transfer of the payment from the bank system to the credit system is not always reflected in the data related to financial status on a real time basis. This problem is due to the circumstances, among others, that a data check process and a database update process take time and that the transfer processing by the bank system is done by batch processing.

A second problem is that, since the user deposits with the bank system money to pay for his or her transaction on credit in the same way as usual depositing of money in the user's account, even if “payment at user's convenience” is desired for credit account settlement and the pertinent sum is deposited in the user's bank account, the transfer to the credit service does not take place until the prescribed settlement day, and accordingly there is a delay in reflection in financial status information. Nor is this time lag consonant with the user's mentality that “there is a temptation to use up any balance in the bank account”. If a user desires “payment at user's convenience”, the user will have to pay in a non-standard way, such as processing a non-automatic transfer to the credit system or going to a counter of the credit system to make a direct payment. Recently, cards exclusively for “payment at user's convenience” have become available, but in this case the default of the credit settlement system is for “payment at user's convenience”, and accordingly can hardly satisfy users' diverse requirements including a default of automatic deduction from the bank account with an option for occasional “payment at user's convenience”.

A user desires “payment at user's convenience” not only when the user wants to pay when he or she can afford to but also when “payment out of bonus” is specified though the semiannual bonus payment day is considerably later than the deduction day, and the user wants to pay upon receipt of the bonus, or when the user, though having a sufficient sum of cash on hand, wants to have his or her financial status raised for a planned overseas trip.

The description for the two problems involved in the conventional system is concluded here.

### SUMMARY OF THE INVENTION

In order to solve the problems noted above, according to the present invention, there is provided a credit settlement system which enables a bank system and a credit system to be linked to each other by storing data representing information on payment received from any user in an IC card, enables the user to deposit in his or her bank account the payment for any transaction on credit, and enables the user to make a transaction on credit reflecting the payment receipt information even immediately after that deposit.

A detailed description will follow.

The first problem that the transfer of the deduction from the user's bank account to the credit system is not reflected in the data related to financial status in the credit account on a real time basis is solved in an embodiment of the invention by storing, on an IC card, data representing payment receipt information and having the data confirmed at the time of transaction on credit to have them temporarily reflected in the data related to financial status. According to the present invention, the data representing payment receipt information is called a token. When the user deposits with a bank service the payment for transaction on credit, the bank system signs the token representing the sum with its encryption key, data and effective period and stores it in the IC card. As the IC card is mounted with an AP for bank service, mutual authentication between the IC card and the system can prevent the token from being mounted on any other IC card than that of this particular account. Then, when the user is to make a transaction on credit immediately after the depositing, as the money deposited immediately before has not yet been transferred from the bank service to the credit service and accordingly is not reflected in the data related to financial status, it would not be reflected in the credit limit according to the prior art. But this problem can be solved by providing the credit system with token verification means. If the credit system checks the token and finds it authentic, it will trust the token and temporarily cause the deposited sum stated thereon to be temporarily reflected in the data related to financial status. Since the data related to financial status are checked with the server on line also on a usual occasion of transaction on credit, signature verification and temporary reflection in the data related to financial status can be accomplished by handing over the token to the server at the same time. As the transfer from the bank system is processed on the day the payment is due, the authenticity of the temporary reflection caused by the token can be actually confirmed.

The second problem posed by the user's desire for “payment at user's convenience” of the price of the transaction on credit and its real-time reflection in the credit limit can be solved in the embodiment of the invention by installing in the bank system a common account for depositing of sums to be transferred to the credit system. In the terminology of the present invention, this account is called a bank account for pool. The regular arrangement for payment is that the user deposits the necessary sum in his or her bank account, from which the billed sum is automatically deducted, but when “payment at user's convenience” is desired, the user can deposit the necessary sum in this bank account for pool or transfer it from his or her own bank account. In this case, too, the bank system stores a token representing the sum, date and effective period into the IC card. Since the bank account for pool is not the user's own personal account, if any sum is deposited in this account irrelevantly to the deduction in settlement of the credit account, no subsequent withdrawal will be possible.

By using this token when making a transaction on credit, the user can have his payment reflected in the credit limit on a real time basis. When the due date comes, the bank system, instead of the usual deduction from the user's personal account, withdraws the pertinent sum from the bank account for pool and transfers it to the credit system. Since transfers are often subject to batch processing, there is little to be modified of the conventional batch processing in the embodiment of the invention as the only difference is whether the source of withdrawal is the user's personal account or the bank account for pool.

Processing of a transaction on credit accomplished by the bank system and the credit system using the two above-described means of solution will be described below in more specific terms. First, as preliminary processing, encryption keys for the token are exchanged between the bank system and the credit system. The encryption key of the bank system subjects the token to a process of generating message signature, and is used for certifying that it is an authentic token generated by the bank. The encryption key of the credit service system encrypts the token, and since the decryption can be done only by the credit system, the key is used for keeping the secrecy of the token. These encryption keys may be either public key certificates, which are open information, or encryption keys generated for exclusive use under a contract between the bank and the credit card company. The usable types of encryption key are not limited to public key type cryptography but also include common key cryptography. Although the following description of the embodiment of the invention presupposes the use of public key cryptography, similar processing is also made possible by exchanging a common key between the systems and generating a derived key according to derivation data. It has to be noted in this case, however, that the data should be closed to all others than the two systems, and that the derivation data should be added in the processing of token delivery to be described afterwards.

Next will be described the processing by the bank system of a deposit by the user. The user demands of the bank system to have the price of his or her transaction on credit deposited. It is checked whether or not the credit system for which the deposit is demanded is under contract and encryption keys have been exchanged by the aforementioned processing. If keys have been exchanged, a token can be prepared. The money to be paid by the user is deposited in the bank account for pool, and the data including its sum, date and effective period are put together into a token. Then, the token is encrypted with a public key received from the credit system, and the encrypted data is signed with the bank system's own secret key. This secret key matches the bank system's own public key delivered to the credit system in the preliminary processing described above. The token signed and encrypted in this way is stored into the IC card. As the IC card is mounted with an AP to perform the bank service, the AP on the IC card and the bank system can authenticate each other. The bank system, after confirming that the IC card is mounted with the user's bank AP, mounts itself with the token. Therefore, the token is not mounted on any other user's IC card, making it possible to prevent illegitimate use by another person. While the token is securely stored in the IC card and protected from being copied, even if it is copied without authorization, any dual use of the token with an unauthorized copy can be prevented by incorporating into the token such data as the preparation date or the effective period of the token or an ID that can uniquely identify the token. To enable the credit system to use the token at the next step of processing, the token is shared in the IC card by the bank AP and the credit AP, or transferred from the bank AP in the IC card to the credit AP. Then comes transfer processing by the bank system. The bank system processes a transfer to the credit system, which is to take place on a preset day. First the bank system receives deduction data from the credit system. These data indicate how much is to be deducted from which user's account. The bank system withdraws from the bank account for pool the sum due from every user having made a transaction on credit under the credit system. If the user has deposited the sum in his or her bank account as usual instead of opting for “payment at user's convenience”, the pertinent sum will not be deposited in the bank account for pool, and accordingly it will be withdrawn from the user's personal account. If the balance in the personal account is insufficient for the sum to be deducted, the credit system will be notified of the impossibility to deduct the sum. This is the same as in the conventional processing. If the sum is normally deducted from the bank account for pool or the user's personal account, a transfer to the credit system will be processed. This is also the same as in the conventional processing. Usually, the combined sum due from all the users is transferred to the credit system in batch processing.

Next will be described the processing by the credit system. First as in preliminary processing, encryption keys for the token are exchanged between the bank system and the credit system. The encryption key of the bank system, performing a process of generating message signature on the token, is used for certifying that it is a valid token generated by the bank. The encryption key of the credit service system is used for encrypting the token to keep the secrecy of the token, which cannot be decrypted by any other party than the credit system. The usable types of these encryption keys are not limited to public key type cryptography but also include common key cryptography or encryption keys generated for exclusive use under a contract between the bank and the credit card company. Although the following description of the embodiment of the invention presupposes the use of public key cryptography, similar processing is also made possible by exchanging a common key between the systems and generating a derived key according to derivation data. It has to be noted in this case, however, that the data should be closed to all others than the two systems, and that the derivation data should be added in the processing of token delivery to be described afterwards.

Next will be described the processing by the credit system of a transaction on credit. The user specifies a transaction on credit when he or she makes a purchase or uses a small loan lending service. On the basis of credit service information read by the client for credit service provider, the credit system checks data related to financial status. This is the way of processing currently in practice, and the data related to financial status indicate whether or not the credit card or the IC card mounted with the credit AP is a lost or stolen card, whether or not its credit limit is high enough for the available amount, and so forth. Then the token on the IC card is extracted, and the validity of the signature on the token is checked with the public key of the bank system received by the preliminary processing. If the validity is confirmed, the credit system decrypts the token with its own secret key. This secret key matches its own public key delivered to the bank system by the above-described preliminary processing. As the AP to perform credit service is mounted on the IC card, mutual authentication is possible between the AP on the IC card and the credit system. After confirming that the IC card is one on which the pertinent user's credit AP is mounted, the credit system extracts the token. Therefore, illegitimate use such as delivery of a token on another user's IC card can be prevented. While the token is securely stored in the IC card and protected from being copied, even if it is copied without authorization, any dual use of the token with an unauthorized copy can be prevented by incorporating into the token such data as the preparation date or the effective period of the token or an ID that can uniquely identify the token. Further, relevant data including the user identification data and the sum to be deposited are analyzed, and caused to be temporarily reflected in the financial status. The sum requested by the user for the transaction on credit is compared with the credit limit according to the financial status to determine whether or not the request can be complied with, and the result of comparison is presented on the client for credit service provider. The rest of the processing is the same as in the conventional processing of a transaction on credit.

The next processing is for the credit system to have a transfer reflected in the financial status. The credit system delivers to the bank system a detailed statement of the user and the sum to be deducted, and receives the transfer of the sum from the bank system on a preset day. The credit system causes the particulars of the transfer to be data reflected in the financial status. Since the information caused to be temporarily reflected by the token can be confirmed on that occasion, any temporary reflection by an invalid token would be revealed by this processing.

Whereas the foregoing description referred to steps of processing that the present invention can provide, processing within the IC card can as well be accomplished by some other way. In the above-described procedure, when the bank system is to store a token, it is preceded by mutual authentication between the bank system and the bank AP on the IC card. Then, after the bank AP transfers the token to, or shares it with, the credit AP in the same IC card, when the-user is to make a transaction on credit, the credit system mutually authenticates the token with the credit AP on the IC card and extracts that token. However, it is also possible for the bank system, when it stores the token, to mutually authenticate with the credit AP on the IC card and to directly store the token into the credit AP. To make this possible, in the processing of the encryption key exchange between the bank system and the credit system, it is necessary for the credit system to hand over to the bank system, in addition to the key for the token, the public key of the credit AP on the IC card and the public key of the bank system signed by the credit system. As the bank system hands over its own signed public key to the credit AP on the IC card, each system owns the other party's public key, thereby enabling the bank system and the credit AP on the IC card to authenticate each other. This formula of storing the token into the IC card is one of the ways to realize the essentials of the present invention. The data contained in a token includes the user's name, the user ID, the sum deposited, the day of depositing, the token ID, the effective period of the token, the bank ID, the bank account number, the credit card company ID and the credit card number.

By the method of transaction on credit provided by the present invention described above, linking between the bank system and the credit system using data on an IC card is made possible, enabling the user to deposit with the bank the sum to be paid for his or her transaction on credit and to use, even immediately after that, the use of credit reflecting the payment receipt information.

It is thus made possible to establish a link between the bank service provider system and the credit service provider system by digitizing, when the user has deposited in the bank account the sum payable for his or her transaction on credit, the information on the deposit and storing the digital data into the IC card.

By providing in the bank service provider system a common account in which sums to be paid by different users to the credit card company are deposited together, it is made possible for each user to opt for “payment at user's convenience” when the user has a surplus balance in the bank account or wants to pay for any other reason.

### BRIEF DESCRIPTION OF THE DRAWINGS

FIG. 1 illustrates the configuration of a payment processing system for credit service according to the prior art;

FIG. 2 illustrates the configuration of a credit settlement system for implementing a method of payment for transactions in credit using a token, which is a preferred embodiment of the present invention;

FIG. 3 schematically illustrates a card system;

FIG. 4 illustrates the basic configuration of the IC card;

FIG. 5 illustrates a sequence according to the invention for storing the token into the IC card according to a deposit by a user and having it reflected in his or her financial status at the time of a transaction on credit;

FIG. 6 illustrates a sequence according to the invention for a bank system to exchange public keys with a credit system;

FIG. 7 illustrates a sequence according to the invention for the bank system to accept a request for a deposit from the user and to prepare and issue a token;

FIG. 8 illustrates a sequence according to the invention for the bank system to transfer the payment for the transaction on credit to the credit system on the due date;

FIG. 9 illustrates a sequence according to the invention for the credit system to exchange public keys with the bank system;

FIG. 10 illustrates a sequence according to the invention for the credit system to accept a request by the user for a transaction on credit, extract and confirm the token, have it reflected in the financial status;

FIG. 11 illustrates a sequence according to the invention for the credit system to accept a transfer of the payment for a transaction on credit from the bank on the due date, have it reflected in the user's financial status and confirm the validity of token information;

FIG. 12 lists examples of items contained in the token to be stored by the bank system to prove a deposit by a user;

FIG. 13 illustrates an example of signature on and encrypting formula for the token;

FIG. 14 illustrates another preferred embodiment of the invention; and

FIG. 15 illustrates still another preferred embodiment of the invention.

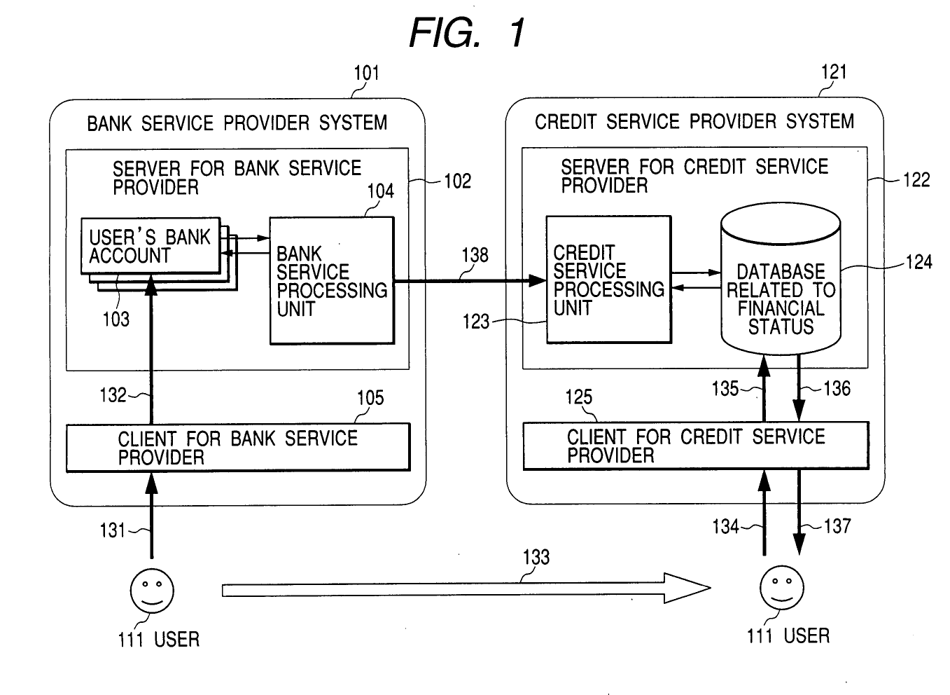

### DETAILED DESCRIPTION OF THE PREFERRED EMBODIMENTS

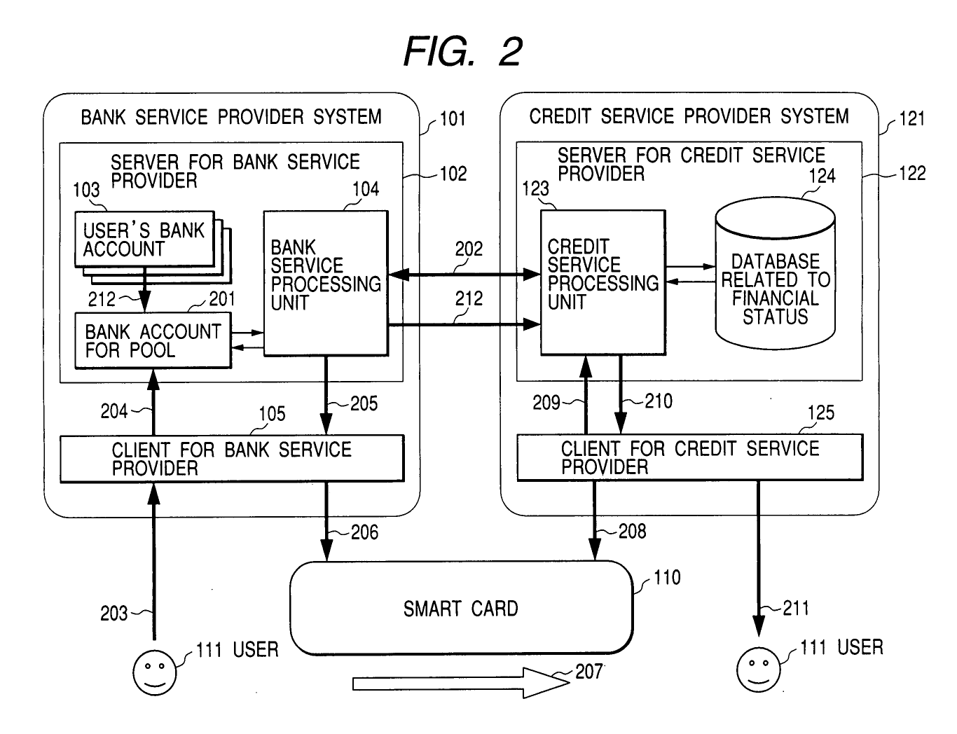

Preferred embodiments of the present invention will be described below with reference to accompanying drawings. The basic configuration of the system pertaining to the invention is illustrated in FIG. 2, wherein reference numeral 101 denotes a bank service provider system (hereinafter abbreviated to bank system), which is used by a bank to perform the management of customer information and account information and usual banking functions including the processing of deposits in and withdrawals from customers' accounts and automatic transfers in and out. In the system, there are a server for bank service provider (102) and clients for bank service provider (105). The server for bank service provider has a user's bank account (103), a bank service processing unit (104) for performing banking functions, and a bank account for pool (201), which characterizes the present invention. The bank account for pool is an account provided by the bank for enabling users to temporarily deposit money to pay for their transactions on credit. Since it is not a personal account for any individual user, once a user deposits money irrelevantly to the regular day of deduction to pay for his or her transaction on credit, that money can never be withdrawn by the user. The bank can manage the fund deposited in this account until the day of deduction. A client for bank service provider is a so-called ATM terminal, installed in each branch of the bank and elsewhere for direct accessing by users.

Reference numeral 121 denotes a credit service provider system (hereinafter abbreviated to credit system), which is used by a credit card company to perform credit service functions including the management of customer information and credit card information, financial status confirmation and payment processing. In the system, there area server for credit service provider (122) and clients for credit service provider (125). The server for credit service provider has a credit service processing unit (123) for performing credit service functions and a database (124) having data which includes client information, card information, customers' financial status information and the like. Clients for credit service provider are installed in retail establishments under contract with the credit card company, and have clients for handling credit services including shopping on credit and cashing.

The bank system and the credit system and the clients and the severs of each system are basically connected via a public network or a private line network, and the exchange of information is accomplished on line by transmission and reception of telegraphic messages. However, depending on the policy of the service operator, the exchange of information can as well be achieved by mailing or directly delivering a hard copy or an information recording medium.

The configuration of the preferred embodiment of the invention also has functions, in the respective processing units (104 and 123).of the bank system (101) and the credit system (121), banking functions including account management and the acceptance of deposits and credit service processing functions including the handling of transactions on credit and the confirmation of financial status information. These processing functions are operated in accordance with computer programs.

Next will be outlined the procedures of settling a transaction on credit and paying for it according to the formulas proposed for the preferred embodiment of the invention.

Whereas settlement of a transaction on credit begins with a deposit of money by the user (111), it should be preceded by certain preliminary processing. It is the processing denoted by reference numeral 202, which is an exchange between the bank system and the credit system of their respective encryption keys. This is used for signing and encrypting a token (to be described afterwards) to be stored into an IC card. The encryption keys to be exchanged may be public key certificates authenticated by a common authenticating agency, such as Verisign, or public keys of paired encryption keys generated for exclusive use between the bank and the credit card company at the time of concluding the contract between them.

Upon normal completion of the preliminary processing described above, it is now possible to process the transaction on credit. First, a deposit by the user is processed. The user (111) having made the transaction on credit accesses a client for bank service provider at any time of his or her choice after the day of the transaction on credit and before the scheduled day of automatic deduction from the bank account (203), and deposits the sum payable in a bank account for pool (201) established by the bank (204). This may be done either by depositing cash or transferring the sum from the user's personal account (103) (212). The bank service processing unit (104) checks whether or not the credit card company to which the payment is due has a pertinent contract with the bank and whether or not encryption keys have been exchanged with the company by the preliminary processing described above, and after confirming these points prepares and issues a token to certify the deposit in the bank account for pool (205). The items to be included in the token include, for instance, the user's name, the sum deposited, the day of depositing, the respective business IDs of the bank and the credit card company, the token ID and the effective period of the credit card. This token is encrypted with the public key of the credit system received by the process denoted by reference numeral 202. Since this process makes it impossible for any other party than the credit system to decrypt and read the data, the secrecy of the token can be maintained. The encrypted token is signed with a secret key of the bank system. This secret key matches the public key sent to the credit system by the process denoted by reference numeral 202, and the verification of the signature when the credit system has received the token enables the credit system to confirm the validity of the token. The token signed and encrypted in this manner is stored into the IC card (110) hold by the user. Since an AP to perform bank service is mounted on the IC card, mutual authentication is possible between the AP of the IC card and the bank system. The bank system, after confirming that the IC card is mounted with the bank AP of the pertinent user, mounts the token on the card. Therefore, the token cannot be mounted on the IC card of a wrong user, and illegitimate use by another person can be prevented. While the token is securely stored in the IC card and protected from being copied, even if it is copied without authorization, any dual use of the token with an unauthorized copy can be prevented by incorporating into the token such data as the preparation date or the effective period of the token or an ID that can uniquely identify the token. To make the token usable by the credit system in the next step of processing, it is shared by the bank AP and the credit AP within the IC card or transferred from the bank AP to the credit AP within the IC card.

Next will be described the processing by the credit system of a transaction on credit. The user specifies a transaction on credit when he or she makes a purchase or uses a small loan lending service. A client for credit service provider reads credit service information and the token (208), and transmits it to the server for credit service provider (209). On the basis of the credit service information received by the credit service processing unit (123), the credit system checks data related to financial status. This is the way of processing currently in practice, and the data related to financial status indicate whether or not the credit card or the IC card mounted with the credit AP is a lost or stolen card, whether or not its credit limit is high enough for the available amount, and so forth. Then the validity of the signature on the token is checked with the public key of the bank system received by the preliminary processing (202). If the validity is confirmed, the credit system decrypts the token with its own secret key. This secret key matches its own public key delivered to the bank system by the above-described preliminary processing (202) As an AP to perform credit service is mounted on the IC card, mutual authentication is possible between the AP on-the IC card and the credit system. After confirming that the IC card is one on which the pertinent user's credit AP is mounted, the credit system extracts the token. Therefore, illegitimate use such as delivery of a token on another user's IC card can be prevented. While the token is securely stored in the IC card and protected from being copied, even if it is copied without authorization, any dual use of the token with an unauthorized copy can be prevented by incorporating into the token such data as the preparation date or the effective period of the token or an ID that can uniquely identify the token. The credit service processing unit (123) analyzes relevant data including the user identification data and the sum to be deposited, and causes them to be temporarily reflected in the financial status database (124). The sum requested by the user for the transaction on credit is compared with the credit limit according to the financial status to determine whether or not the request can be complied with, and the result of comparison is presented on the client for credit service provider (210). On the basis of this result, the client for credit service provider either goes ahead with the processing of the transaction on credit or suspends the processing (211). The rest of the processing is the same as in the conventional processing of a transaction on credit.

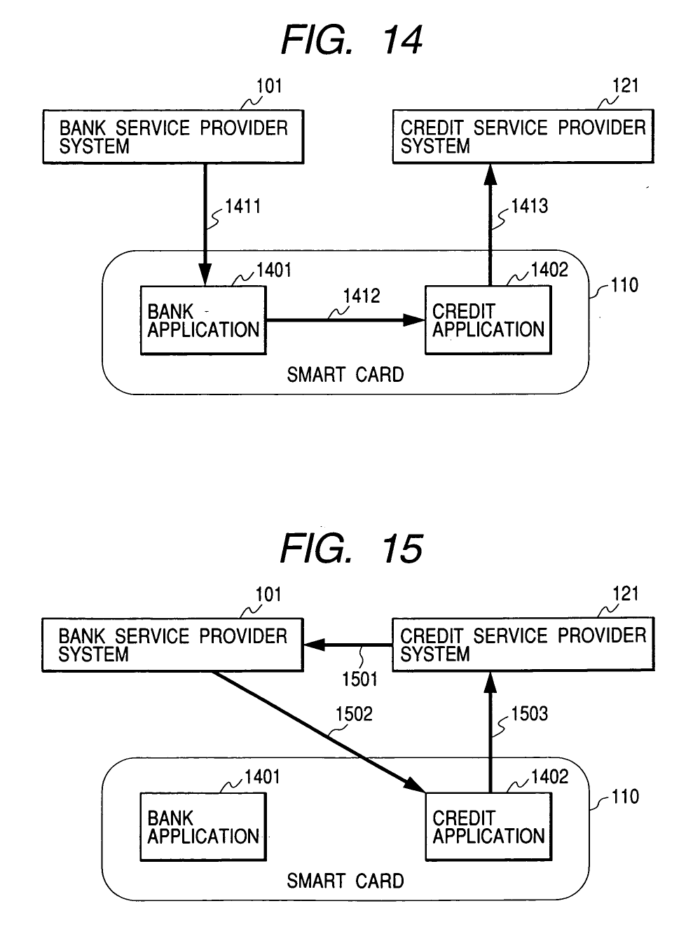

Next processing is to transfer the payable sum on the day of automatic deduction from the bank account. The bank system receives deduction data from the credit system. The data indicates how much is to be deducted from which user's account. The bank system withdraws from the bank account for pool the sum due from every user having made a transaction on credit under the credit system, and processes a bank transfer (212) to the credit system on a preset day. If the user has deposited the sum in his or her bank account as usual instead of opting for “payment at user's convenience”, the pertinent sum will not be deposited in the bank account for pool, and accordingly it will be withdrawn from the user's personal account. If the balance in the personal account is insufficient for the sum to be deducted, the credit system will be notified of the impossibility to deduct the sum. This is the same as in the conventional processing. If the sum is normally deducted from the bank account for pool or the user's personal account, a transfer to the credit system will be processed. This processing of a transfer to the credit system (212) is also the same as in the conventional processing, and often the combined sum due from all the users is transferred to the credit system in batch processing.

Whereas the basic configuration of and processing by the system according to the invention have been described above, two methods of processing within the IC card, and the processing on the system side varies with the choice out of the two methods. This point will be described with reference to FIG. 14 and FIG. 15. FIG. 14 illustrates a first method which has been described so far, whereby the bank system, when storing the token, mutually authenticates it with the bank AP on the IC card (1411). Then, after the bank AP transfers the token to or shares it with the credit AP on the same IC card (1412), the credit system, if the user is to make a transaction on credit, mutually authenticates the token with the credit AP on the IC card and extracts it (1413). However, it is also possible for the bank system, when it is to store the token, to mutually authenticate it with the credit AP on the IC card and directly store the token into the credit AP. This second method will be described with reference to FIG. 15. While the exchange of encryption keys between the bank system and the credit system is processed in advance, the public key of the credit AP on the IC card and the public key of the bank system, signed by the credit system, are delivered in advance by the credit system to the bank system in addition to the keys for the token (1501). The bank system, instead of communicating the bank AP within the IC card, communicates with the credit AP by the public key of the credit AP within the IC card, received from the credit system at the step denoted by reference numeral 1501 and, after mutually authenticating, stores the token (1502). In this case, regarding the processing denoted by reference numeral 1503 of the credit system to extract the token, no change occurs because it is a matter of communication between the credit system and the credit AP within the IC card.

Further, a set of items contained in the data known as a token are illustrated in FIG. 12. By incorporating the user's name, the user ID, the sum deposited, the day of depositing, the token ID, the effective period of the token, the bank ID, the bank account number, the credit card company ID and the credit card number, it is made possible to prevent dual use of the token or its use by anybody else than its authentic user.

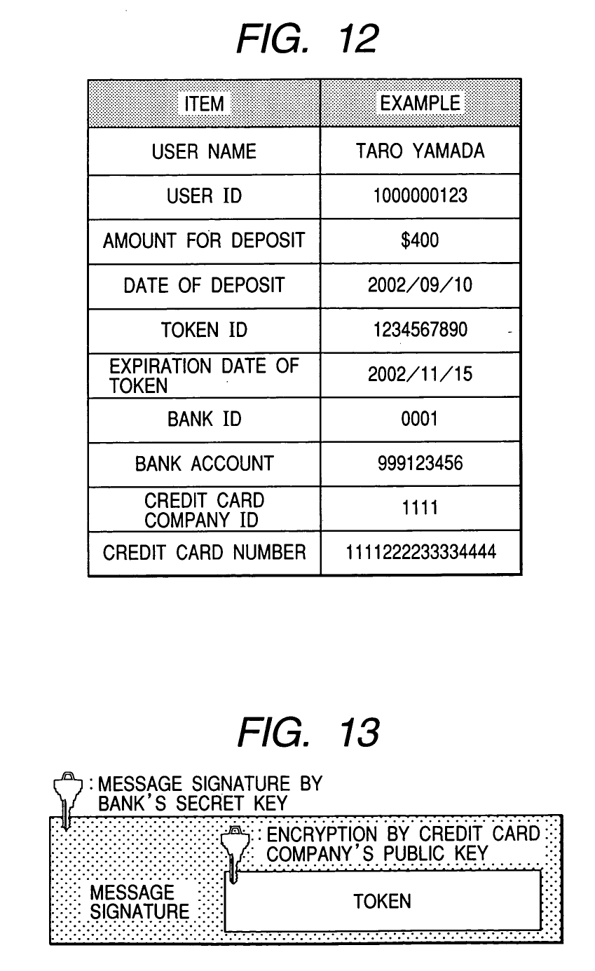

The encryption of the signature on the token will be described with reference to FIG. 13. First, the bank system encrypts with the public key of the credit system the token having contents exemplified in FIG. 12. This makes it impossible for token to be decrypted with anything else than the secret key of the credit system and to keep its secrecy within the credit system. Next, the bank system signs the token wits own secret key. As the public key matching this secret key is delivered to the credit system in advance, the credit system is enabled to verify that the pertinent token has been prepared by the bank system.

The overall flow including the system configuration has been described so far. Next, the individual constituent elements of the system will be described.

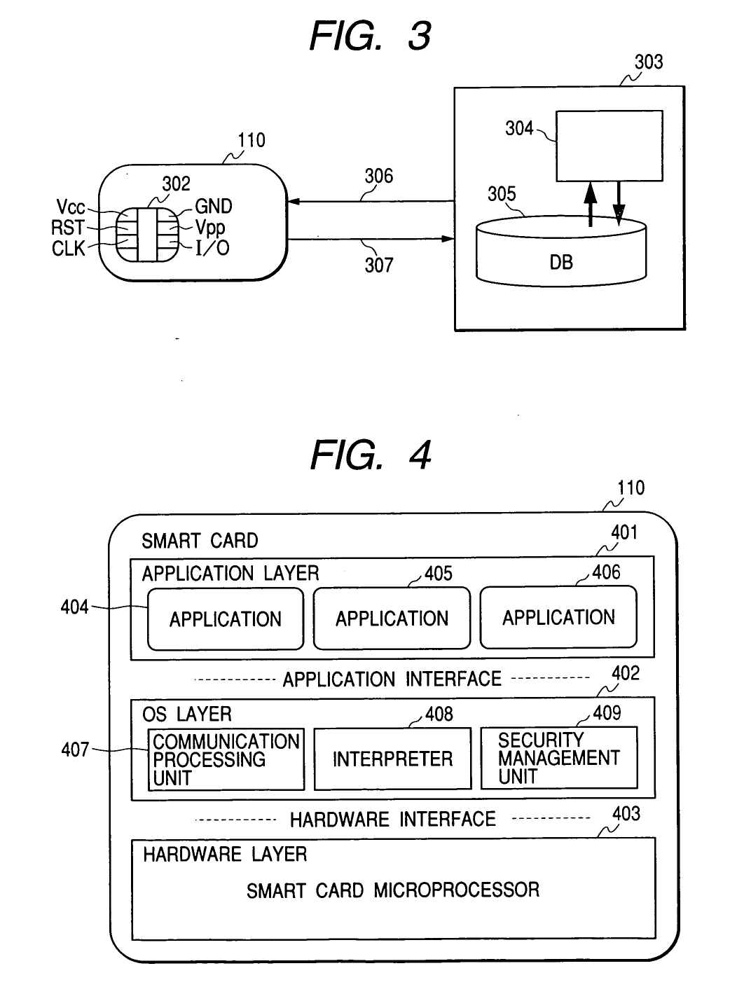

FIG. 3 schematically illustrates the IC card system. Here is shown an example in which the IC 110 has within it a chip 302 exchanging data with a reader/writer 303 (or a terminal 303 having a reader/writer). The reader/writer contains a control processor 304 and a magnetic disk 305 which serves as a database. The IC card 110 is shown to have, as usual, terminals including power feed source (Vcc), ground (GND), reset (RST), input/output (I/O) and clock (CLK) terminals for instance. In the drawing, reference numeral 306 denotes various inquires regarding the card ID, for instance from the reader/writer 303 to the IC card 110, reference numeral 307, replies to such inquiries from the IC card. For the communication of various items of information, the conventional system is satisfactory.

In specific terms, in the IC chip within the IC card, the aforementioned application is mounted in the memory area. Usually as the memory, a random access memory (RAM), an electrical erasable programmable read only memory (EEPROM), a read only memory (ROM) or the like is used.

Next, FIG. 4 illustrates the logical configuration of the basic areas within the IC mounted on such an IC card (110). The IC, like a usual microcomputer, has a hardware layer (403), an OS layer (402) on which an OS is mounted and an application layer (401) on which applications are mounted. The multi-application mounting capability here means that a plurality of applications (404 through 406) can be mounted on the application layer (401). The initial mounting of applications means that the distribution of the IC card to each of applicants for its use in a state in which these applications (404-406) are already mounted at the time of card issue. The dynamic loading capability means that these applications (404-406) can be mounted or deleted after the issue of the card. The OS layer (402), having a communication processing unit (407), an interpreter (408) and a security management unit (409), receives commands from external terminals and transfers the commands of applications. As would be expected, between an application layer (401) and the OS layer (402) is installed an application interface, and between the OS (402) and the hardware layer (403), a hardware interface.

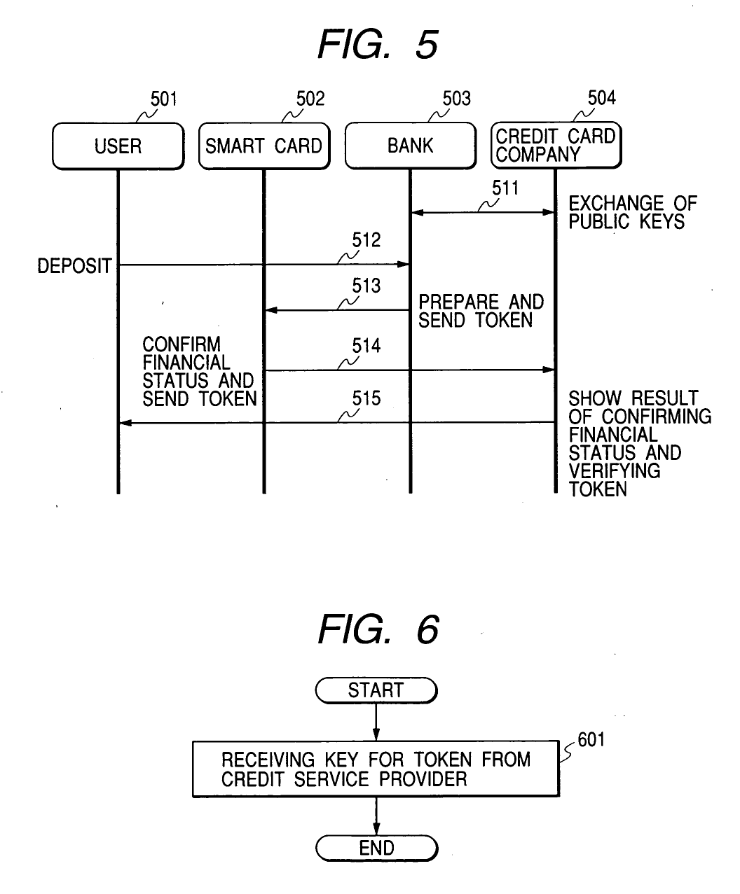

Next will be described a specific method of processing a transaction on credit. First will be described the processing of a deposit, a transaction on credit and the transfer of the payable sum by a user with reference to the sequence shown in FIG. 5. At the beginning, encryption keys are exchanged between the bank (503) and the credit card company (504) for the processing of a token (step 511). The user (501) having used the credit service deposits with the bank the sum to pay for it at his or her convenience not later than its due date (step 512). The bank prepares a token to certify the depositing, and transmits it to the user's IC card (502) (step 513). Then, when the user uses the credit service, extracts from the IC card credit service information including the credit card number and the token, and transmits them to the credit card company (step 514). The credit card company checks according to the received credit service information whether or not the card is a lost or stolen card, whether or not its effective period has expired and other data related to financial status. It also confirms the validity of the received token, and causes the deposited sum stated on the token to be temporarily reflected in the credit limit. It assesses the credit limit temporarily reflecting the deposited sum in comparison with the sum of the requested transaction on credit, presents the result of assessment to the user (step 501), and thereafter continues the conventional processing of the transaction on credit.

Details of the method of transacting on credit in the embodiment of the invention so far described will now be described with reference to flow charts (FIG. 6 through FIG. 11) of the operations of the bank system and the credit system. These charts show in more detail the sequence of FIG. 5. FIG. 6 through FIG. 8 are flow charts of the operation of the bank system.

First will be described the processing of the key exchange by the bank system with reference to FIG. 6. The bank system exchanges public keys with the credit system (step 601). As stated above, when the bank system is to directly store a token into the credit AP within the IC card in connection with processing within the IC card, it receives at step 601 from the credit system the credit AP public key for the establishment of communication and mutual authentication and the public key of the bank system signed by the credit system.

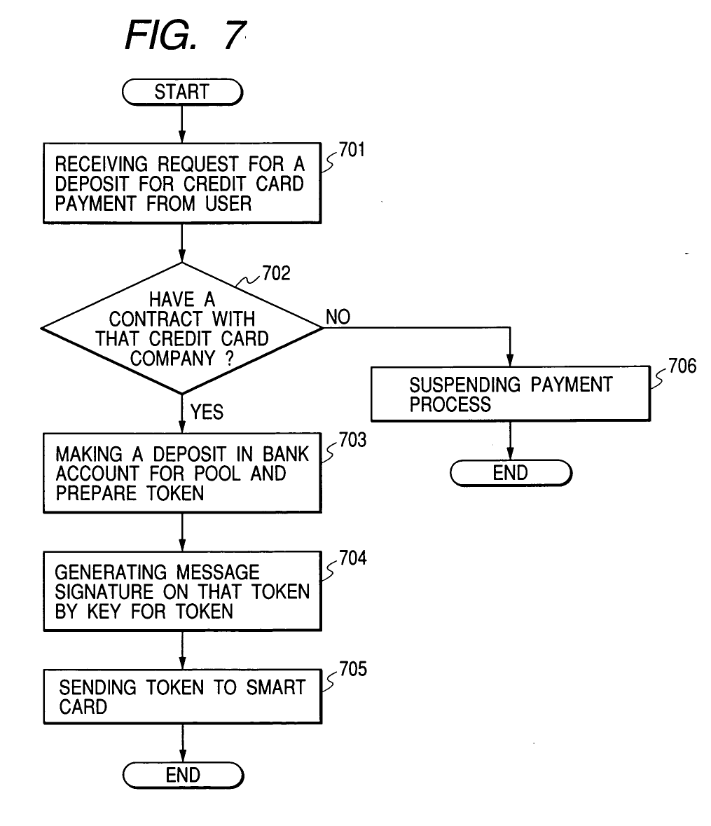

Next will be described the processing of a deposit by the user with the bank system with reference to FIG. 7. The user demands of the bank system to accept a deposit of money to pay for a transaction on credit (step 701). The bank system checks whether or not it has a pertinent contract with the credit system for which the deposit is demanded and has exchanged encryption keys processed as stated above (step 702). If it has no such contract, the bank system will inform the user that payment in settlement of the credit by the method according to the invention is impossible and stops processing (step 706). If it does have such a contract, as it can prepare a token, the bank system will accept the deposit by the user into the bank account for pool, and develops data including the sum, date and effective period into a token (step 703). Then it encrypts the token with a public key received from the pertinent credit system, and signs the encrypted data with its own secret key (step 704). This secret key matches the bank system's own public key handed over to the credit system in the preliminary processing described above. The token signed and encrypted in this manner is stored into the IC card (step 705). As AP for performing bank service is mounted on the IC card, mutual authentication is possible between the AP on the IC card and the bank system. The bank system, after confirming that the user's bank AP is mounted on the IC card, mounts it with the token. To make it usable by the credit system at the next step of processing, the token is shared between the bank AP and the credit AP within the IC card, or the token is transferred from the bank AP to the credit AP within the IC card. Or if the public key of the credit AP within the IC card has been received from the credit system, mutual authentication with the credit AP within the IC card is possible, and the token is stored after such mutual authentication.

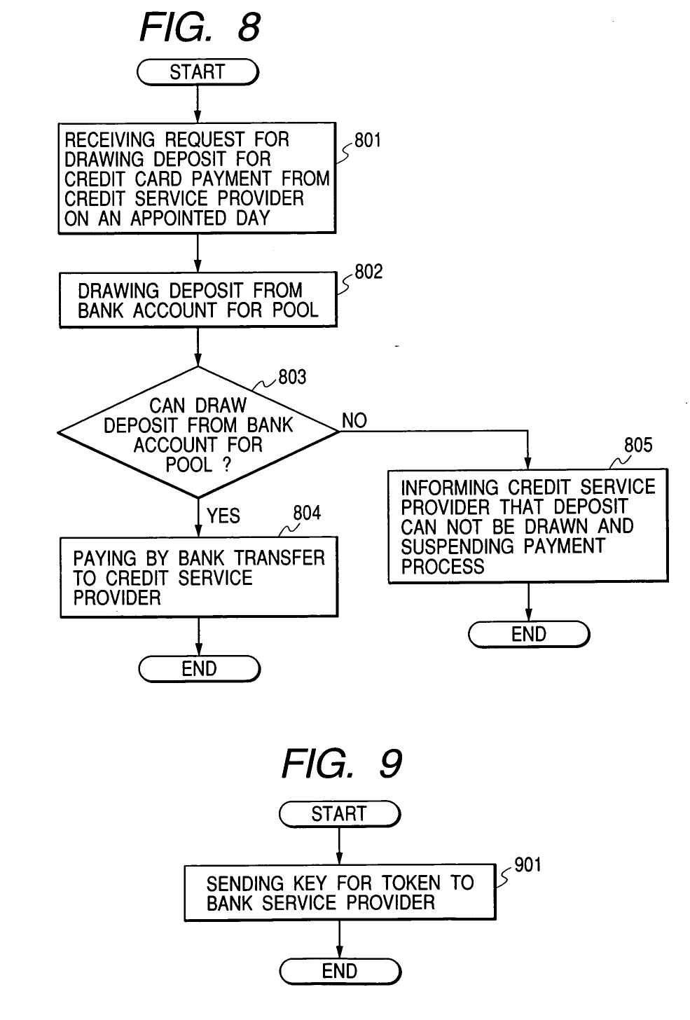

Now will be described the processing of a transfer from the bank system with reference to FIG. 8. The bank system processes a transfer of the user's payment to the credit system on a preset day. First, it receives deduction data from the credit system (step 801). These data indicate how much is to be deducted from which user's account. The bank system withdraws from the bank account for pool the sum due from every user having made a transaction on credit under the credit system (step 802). If the user has deposited the sum in his or her bank account as usual instead of opting for “payment at user's convenience”, the pertinent sum will not be deposited in the bank account for pool, and accordingly it will be withdrawn from the user's personal account. If the balance in the personal account is insufficient for the sum to be deducted, the credit system will be notified of the impossibility to deduct the sum (step 805). This is the same as in the conventional processing. If the sum is normally deducted from the bank account for pool or the user's personal account, a transfer to the credit system will be processed (step 804). This processing is also the same as in the conventional processing, and often the combined sum due from all the users is transferred to the credit system in batch processing.

FIG. 9 through FIG. 11 are flow charts of the operations of the credit system in this embodiment of the invention.

First will be described the processing of a key exchange by the credit system with reference to FIG. 9. The credit system exchanges public keys with the bank system (step 901). As stated above, when the bank system is to directly store a token into the credit AP within the IC card in connection with processing within the IC card, the credit system has to send to the bank system at step 901 the credit AP public key for the establishment of communication and mutual authentication and the public key of the bank system signed by the credit system.

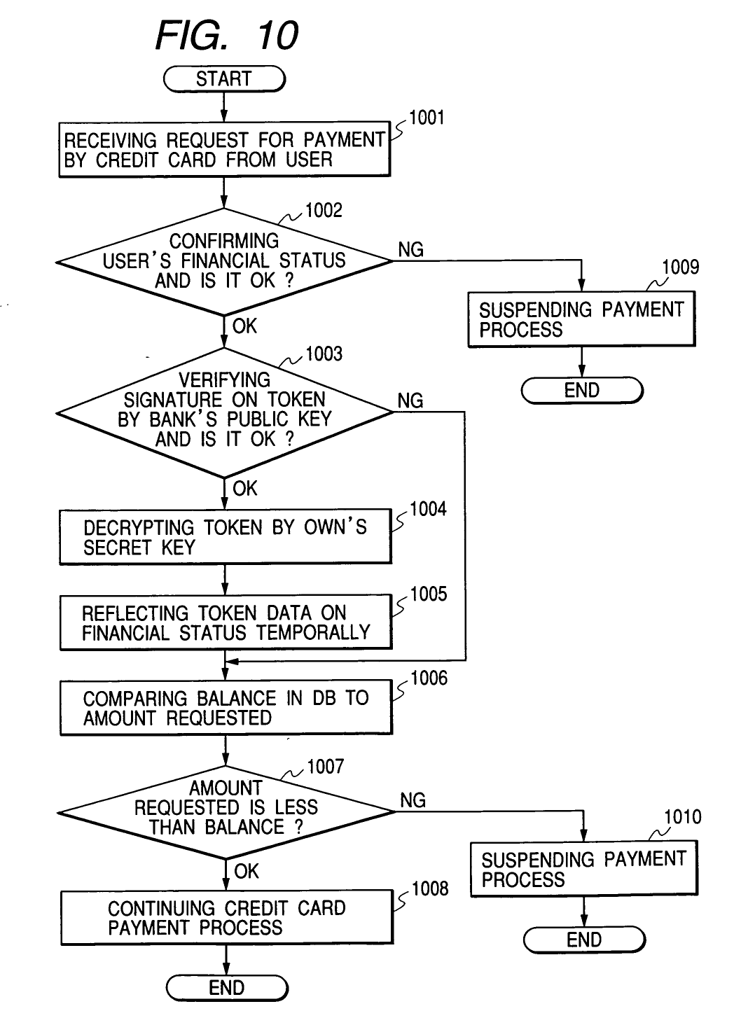

Next will be described the processing by the credit system of a transaction by a user on credit with reference to FIG. 10. The user specifies a transaction on credit when he or she makes a purchase or uses a small loan lending service, and a client for credit service provider receives this designation (step 1001). On the basis of the credit service information received by the client for credit service provider, the credit system checks data related to financial status (step 1002). This is the way of processing currently in practice, and the data related to financial status indicate whether or not the credit card or the IC card mounted with the credit AP is a lost or stolen card, whether or not its credit limit is high enough for the available amount, and so forth. If there is any problem in the data related to financial status, unavailability will be made known to the user, and the processing will be stopped (step 1009). If there is no problem in the data related to financial status, the credit system will extract the token on the IC card, verify the signature on the token with the public key of the bank system received in the preliminary processing, and confirm its validity (step 1003). If its validity cannot be confirmed or no token is present in the IC card, steps related to the token will be dispensed with, to be directly followed by step 1006. If the validity of the token is confirmed at step 1003, the credit system will decrypt the token with its own secret key (step 1004). This secret key matches the credit system's own public key handed over to the bank system in the preliminary processing described above. Next, the credit system analyzes relevant data including the user identification data and the sum to be deposited, and causes them to be temporarily reflected in the financial status database (step 1005). The sum requested by the user for the transaction on credit is compared with the credit limit according to the financial status (step 1006). On the basis of the result of this comparison, it is determined whether the desired transaction is available for the user (step 1007), and if the sum of the desired transaction is above the credit limit, unavailability will be made known to the user and the processing will be stopped (step 1010). If the sum of the desired transaction is within the credit limit, availability will be made known to the user and the processing of the intended use of the credit service will continue (step 1008). The rest of the processing is the same as in the conventional processing of a transaction on credit.

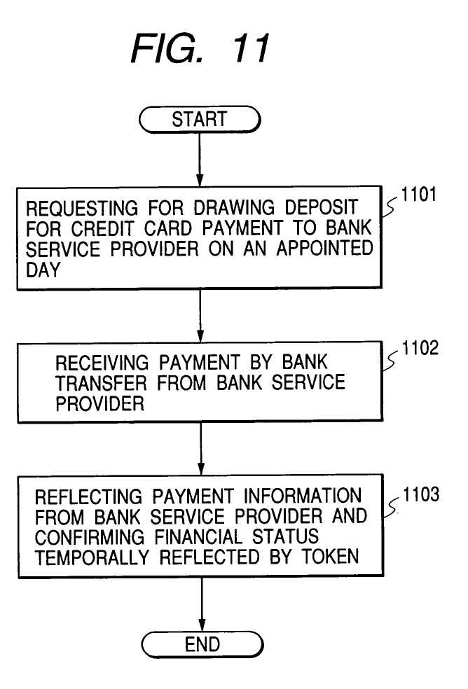

Next will be described the processing of a transfer to the credit system with reference to FIG. 11. The credit system delivers to the bank system a statement in which users and the respective sums due from them are matched (step 1101), and receives a transfer of the payment from the bank system on a preset day (step 1102). The credit system causes particulars of the transferred payment to be reflected in the data related to financial status (step 1103). As the information caused to be temporarily reflected by the token can be confirmed on that occasion, any temporary reflection by an invalid token would be revealed by this processing.

The preferred embodiment of the present invention has been described so far. The IC card may be of a contact type or a non-contact type, but the embodiment of the invention is applicable irrespective of the configuration of the IC card itself.

As hitherto described, the embodiment of the invention makes the following possible.

(1) Where a user makes use of a credit service and pays for it by having the pertinent sum automatically deducted from his or her bank account and the user deposits the sum with the bank not later than the due date, the deposit can be reflected on a real time basis in his or her credit limit by securely storing in the IC card the information that the deposit has been made and uploading it onto the credit system when the user makes a transaction on credit the next time.

(2) In addition, the user is enabled to make “payment at user's convenience” through one of the bank ATMs he or she normally uses when the user has enough surplus cash on hand. Moreover, the deposit can be reflected on a real time basis in his or her credit limit in the same way as in (1) above by securely storing in the IC card the information that the deposit has been made.

What is claimed is:

1. A program for controlling a bank service provider system performing banking functions,
said bank service provider system comprising:
a client for bank service provider to be connected to an IC card; and
a server for bank service provider performing banking functions on a user's bank account for automatic deduction in which the user's money is to be deposited, wherein
said program enables said server for bank service provider to execute the steps of:
causing said bank service provider to reflect a deposit by said user in said bank account for automatic deduction,
storing deposit information certifying said deposit into the IC card via said client for bank service provider, and
transferring the money to pay for the use of credit service on the basis of a financial status in which said deposit information is reflected from said bank account to said credit service provider system.

2. The program according to claim 1, wherein
said bank account is a common bank account for pooling sums to be transferred to said credit service provider system and allows no withdrawal by any user once he or she has made a deposit in it.

3. The program according to claim 1, wherein
said deposit information includes at least the sum deposited.

4. The program according to claim 1, wherein
at the step of storing deposit information certifying said deposit into the IC card,
said program enables said server for bank service provider to execute the steps of:
encrypting said deposit information with a public key of said credit service provider system; and
as signing a signature with a secret key of said bank service provider system.

5. A program for controlling a credit service provider system performing credit service,
said credit service provider system comprising:
clients for credit service provider each to be connected to an IC card; and
a server for credit service provider which has a financial status database for managing data related to financial statuses of users and performing credit service, wherein said
program enables said server for credit service provider to execute the steps of:
receiving from the IC card, via one of said clients for credit service provider, deposit information certifying a deposit by a user into a bank account for automatic deduction;
causing said deposit information to be reflected in data related to financial status managed by said financial status database;
determining the availability of credit service to said user on the basis of said data related to financial status and providing credit service to the user via said clients for credit service provider; and
receiving a transfer of payment for the use of said credit service from a bank account managed by said bank service provider system performing banking functions.

6. The program according to claim 5, wherein
said bank account is a common bank account for pooling sums to be transferred to said credit service provider system and allows no withdrawal by any user once he or she has made a deposit in it.

7. The program according to claim 6, wherein
said deposit information includes at least the sum deposited.

8. The program according to claim 6, wherein
at the step of causing deposit information to be reflected in said data related to financial status,
said program enables said server for credit service provider to execute the steps of:
verifying with a public key of said bank service provider system with a signature assigned to said deposit information; and
decrypting said deposit information with a secret key of said credit service provider system.

9. The program according to claim 7, wherein
at the step of determining the availability of credit service to said user on the basis of said data related to financial status and making the credit service available,
said program enables said server for credit service provider to execute the steps of:
causing said sum deposited in said deposit information to be temporarily reflected in the credit limit in said data related to financial status; and
assessing the temporarily reflecting credit limit in comparison with the sum of a requested transaction on credit.

10. An IC card with a built-in IC chip comprising a memory and a communication unit, wherein
said IC card receives from a bank service provider system performing banking functions, via the communication unit, deposit information certifying a deposit by a user into a bank account for automatic deduction, stores said deposit information into said memory, and
when said user is to make use of credit service, provides said deposit information stored via said communication unit to a credit service provider system performing said credit service.

11. The IC card according to claim 10, wherein
said bank account is a common bank account for pooling sums to be transferred to said credit service provider system and allows no withdrawal by any user once he or she has made a deposit in it.

12. The IC card according to claim 11, wherein said deposit information includes at least the sum deposited.

13. The IC card according to claim 12, wherein
in storing said deposit information into said memory or providing said deposit information which is stored,
said bank service provider system and credit service provider system exchange in advance public keys matching secret keys they respectively hold.
